(19) United States
(12) Patent Application Publication
(10) Pub. No.: US 2025/0222752 A1
(43) Pub. Date: Jul. 10, 2025

(54) Vehicle Hail Shield

(71) Applicant: Richard Villalpando, Carlsbad, NM (US)

(72) Inventor: Richard Villalpando, Carlsbad, NM (US)

(21) Appl. No.: 18/408,003

(22) Filed: Jan. 9, 2024

(51) Int. Cl. B60J 11/04; B32B 3/30; B32B 5/02; B32B 5/18; B32B 5/24; B32B 7/09

(52) U.S. Cl. CPC B60J 11/04; B32B 3/30; B32B 5/02; B32B 5/18; B32B 5/245; B32B 7/09; B32B 2571/00

(57) ABSTRACT

The Emergency Hail Protection Cover is the only cover of its kind with an intelligent three-layer construction to ensure a car is shielded from hail damage and sun-induced wear and can be effortlessly deployed and compacted for storage. This unprecedented product is uniquely designed with practicality in mind, and it can easily become a go-to vehicle accessory for diverse users. A vehicle cover disclosed includes a layered cover comprising an outer protective layer, a middle padded layer and an inner smooth layer, a quilted grid of creases comprising a reinforcement stitching along each of the creases, a horizontal buckle configured to gather the cover horizontally along a horizontal crease, and a vertical buckle configured to gather the cover vertically along a vertical crease.

### BACKGROUND

Hailstorms can be a vehicle owner's worst nightmare, causing extensive and costly damage to a car's exterior and interior design which then leads to high insurance claims in effort to repair the vehicle for operation post-damage. Often these weather calamities come with little to no warning furthering the vulnerability of a car exposed via street parking or within an open lot. There have been no products available as original equipment or as an aftermarket to address this problem.

An apparatus that provides protection for your vehicle from hailstorms is not being met by any known device or system at present. There have been no products available as original equipment or as an aftermarket to address this problem either.

### SUMMARY OF THE INVENTION

The main purpose the Vehicle Hail Shield is to provide users with an effective method of protecting a vehicle from hail damage.

A vehicle cover disclosed includes a layered cover comprising an outer protective layer, a middle padded layer and an inner smooth layer, a quilted grid of creases comprising a reinforcement stitching along each of the creases, a horizontal buckle configured to gather the cover horizontally along a horizontal crease, and a vertical buckle configured to gather the cover vertically along a vertical crease.

### BRIEF DESCRIPTION OF THE DRAWINGS

FIG. 1 is a left view of the Vehicle Hail Shield in accordance with an embodiment of the present disclosure.

FIG. 2 is a closeup view showing the buckle fastener configured to gather the shield via gather straps in accordance with an embodiment of the present disclosure.

FIG. 3 is a closeup side view showing a hook in the buckle fastener E attached to the shield in accordance with an embodiment of the present disclosure.

FIG. 4 is a cross sectional view of the shield, also known as a cover, showing the disclosed layers in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure, the terms ‘shield’ and ‘cover’ are used interchangeably and are therefore given the same meaning. A ‘crease’ is also used to describe a reinforced seam in the shield and in the cover similar to a quilting design and fabrication as disclosed.

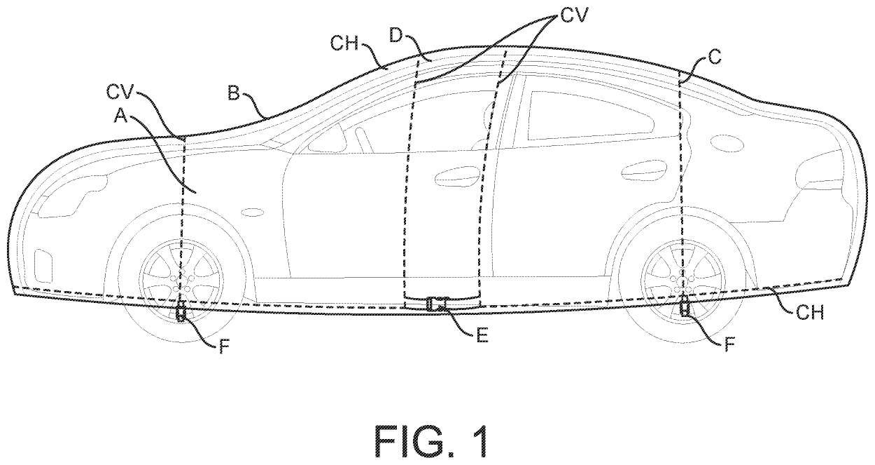

FIG. 1 is a left elevational view of the Vehicle Hail Shield showing: emergency hail protection cover comes in different sizes referenced as A, outer layer made of canvas material referenced as B, middle layer made of 2″-3″ foam material foldable with creases referenced as CV and CH, inner layer made of micro-fiver referenced as D, buckle fastener referenced as E, gather straps G, hook fastener to secure cover at wheel rim referenced as H, and tire T in accordance with an embodiment of the present disclosure. The vertical creases CV and the horizontal creases CH enable tightening the shield on any particular make and model of car by a grid of creases which are reinforced seams of the layers of material disclosed.

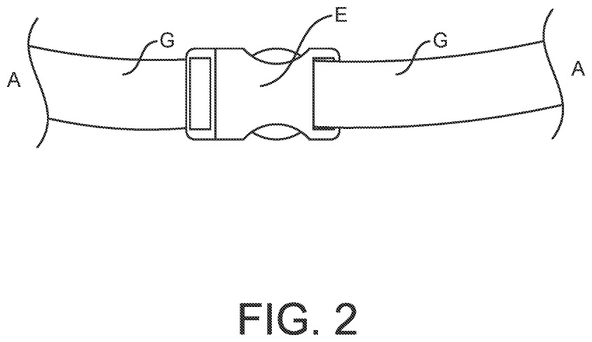

FIG. 2 is a close up view of the Vehicle Hail Shield showing: buckle fastener referenced as E configured to gather the shield A via the straps G in accordance with an embodiment of the present disclosure. A horizontal crease CH along a bottom seam of the shield reinforces gathering the shield in halves, in thirds and fourths etc depending on placements of the respective CH horizontal creases.

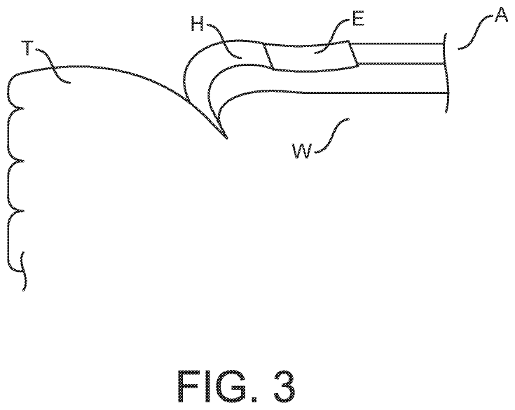

FIG. 3 is a closeup side view showing the hook in the buckle fastener attached to the cover in accordance with an embodiment of the present disclosure. The hook H is applied at a juncture of the tire T and the wheel W in order to tighten the shield in a vertical direction via a vertical crease CV as shown.

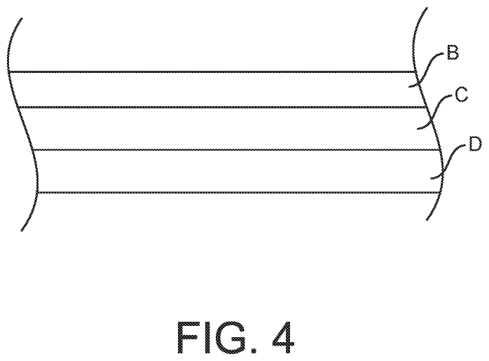

FIG. 4 is a cross sectional view of the shield, also known as a cover, showing the disclosed layers in accordance with an embodiment of the present disclosure. The top protective layer A can be a canvas and other materials impermeable to hail and elements. The next layer B is a foam material for cushioning the vehicle from impact from hail and other weather elements and various and spurious dents. The inner most layer D is a smooth micro fiber type material designed to be scratch free of the vehicle's surface despite rubbing across in even a shear like parallel direction.

The present disclosed Vehicle Hail Shield, also known as “Emergency Hail Protection Cover”, offers a modern accessory that ensures a vehicle remains protected even during the most intense storms. Meant to complement any make or model automobile, the Emergency Hail Protection Cover introduces a novel three-layer cover to offer unbeatable protection and convenience for vehicle owners. The waterproof top layer forms a robust barrier against hail, rain and sun rays. The second layer, cleverly crafted with pool noodle foam, provides additional cushioning to absorb the impact of hailstones ensuring maximum protection to a vehicle's surface. The third layer, featuring soft microfiber cloth, rests gently against the car safeguarding it from scratches and abrasions ensuring that a vehicle stays pristine. When hail or harsh sunlight threatens, one would simply drape the cover over a vehicle and use the drawstring at the bottom to secure it firmly in place. The hassle-free setup allows for quick and efficient protection when it is most needed. Beyond hail protection, the Emergency Hail Protection Cover also shields vehicles exterior and interior; thus, keeping a vehicle cool and protected from harmful sun exposure. This innovative, top-quality product may benefit car owners worldwide and therefore may prove to be essential in the automotive/safety industry.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A vehicle cover comprising:
a layered cover comprising an outer protective layer, a middle padded layer and an inner smooth layer;
a quilted grid of creases comprising a reinforcement stitching along each of the creases;
a horizontal buckle configured to gather the cover horizontally along a horizontal crease; and
a vertical buckle configured to gather the cover vertically along a vertical crease.

2. The vehicle cover of claim 1, wherein the outer protective layer is a canvas material.

3. The vehicle cover of claim 1, wherein the middle padded layer comprises a nominal two to three inch foam material foldable at the creases.

4. The vehicle cover of claim 1, wherein the inner smooth layer comprises a micro-fiber material.

5. The vehicle cover of claim 1, wherein the quilted grid of creases comprises a plurality of vertical creases and a plurality of horizontal creases.

6. The vehicle cover of claim 1, wherein the horizontal buckle spans a 12 inch section of the cover between two creases.

7. The vehicle cover of claim 1, further comprising a plurality of horizontal buckles.

8. The vehicle cover of claim 1, further comprising a left strap and a right strap each joined to a disparate crease and to the horizontal buckle.

9. The vehicle cover of claim 1, further comprising a plurality of vertical buckles.

10. The vehicle cover of claim 1, further comprising a hook set between a tire and a tire rim of the vehicle and joined to a vertical buckle.

11. The vehicle cover of claim 1, wherein a vertical buckle is joined to a vertical crease.

12. The vehicle cover of claim 1, further comprising four vertical buckles disposed adjacent four wheels of the vehicle.

13. The vehicle cover of claim 1, further comprising a horizontal crease at a top of the cover corresponding to a top of the vehicle.

14. The vehicle cover of claim 1, further comprising a vertical crease adjacent each of four wheels of the vehicle.

15. The vehicle cover of claim 1, further comprising a horizontal crease adjacent a roof of the vehicle corresponding to a door jam at the roof.
